(19) United States
(12) Patent Application Publication
(10) Pub. No.: US 2025/0015398 A1
(43) Pub. Date: Jan. 9, 2025

(54) BATTERY AND ELECTRONIC DEVICE INCLUDING THE SAME

(71) Applicant: Samsung Electronics Co., Ltd., Suwon-si (KR)

(72) Inventors: Shihyun KIM, Suwon-si (KR); Sihoon YOUM, Suwon-si (KR); Juneyoung HUR, Suwon-si (KR)

(21) Appl. No.: 18/735,820

(22) Filed: Jun. 6, 2024

Related U.S. Application Data
(63) Continuation of application No. PCT/KR2024/006926, filed on May 22, 2024.

(30) Foreign Application Priority Data
Jul. 5, 2023 (KR) 10-2023-0087332
Aug. 11, 2023 (KR) 10-2023-0105425

(51) Int. Cl. H01M 50/105; H01M 10/42; H01M 50/184; H01M 50/186; H02H 7/18

(52) U.S. Cl. CPC H01M 50/105; H01M 10/4257; H01M 50/184; H01M 50/186; H01M 2220/30; H02H 7/18

(57) ABSTRACT

An electronic device according to an embodiment of the disclosure may include a housing. The electronic device may include a battery disposed inside the housing and configured to supply power to the electronic device. The battery may include an electrode assembly. The battery may include an upper pouch and a lower pouch disposed to accommodate the electrode assembly. The battery may include a sealing part formed at edges of the upper pouch and the lower pouch to seal the electrode assembly. The lower pouch may include a first cup recessed downwardly and configured to accommodate at least a portion of the electrode assembly. The first cup may have a front side, a rear side opposite to the front side, and a lateral side connecting the front side and the rear side. The sealing part may include a front sealing part extending from the front side of the first cup and disposed at a lower position than an upper end of the rear side of the first cup.

### CROSS-REFERENCE TO RELATED APPLICATION(S)

This application is a continuation application, claiming priority under § 365 (c), of an International application No. PCT/KR2024/006926, filed on May 22, 2024, which is based on and claims the benefit of a Korean patent application number 10-2023-0087332, filed on Jul. 5, 2023, in the Korean Intellectual Property Office, and of a Korean patent application number 10-2023-0105425, filed on Aug. 11, 2023, in the Korean Intellectual Property Office, the disclosure of each of which is incorporated by reference herein in its entirety.

### BACKGROUND

### 1. Field

The disclosure relates to a battery having a pouch for receiving an electrode assembly formed in an asymmetrical shape and an electronic device including the same.

### 2. Description of Related Art

A portable electronic device may include a housing and a battery, disposed inside the housing, to supply power to the electronic device. The battery may include an electrode assembly that generates voltage based on a movement of electrons, and a pouch that accommodates the electrode assembly. Edges of the pouch may be sealed to insulate the electrode assembly contained within the pouch.

### SUMMARY

A battery may further comprise a protection circuit module (PCM) connected to an electrode assembly to protect and control the battery. The PCM may be located on a side of a front sealing part of a pouch. A height of the front sealing part may vary depending on a forming shape of the pouch. For example, when the height of the front sealing part is tall (or long) based on the forming shape of the pouch, interference may occur between a supporting bracket of a housing for receiving the battery and a flexible printed circuit board (FPCB) connected to the PCM, requiring that a portion of the supporting bracket may be cut to avoid the interference.

Various embodiments of the disclosure may provide a battery capable of adjusting a height of a front sealing part where a PCM is seated by forming a pouch in an asymmetrical shape and an electronic device including the battery.

An electronic device according to an embodiment of the disclosure may include a housing. The electronic device may include a battery disposed inside the housing and configured to supply power to the electronic device. The battery may include an electrode assembly. The battery may include an upper pouch and a lower pouch disposed to accommodate the electrode assembly. The battery may include a sealing part formed at edges of the upper pouch and the lower pouch to seal the electrode assembly. The lower pouch may include a first cup recessed downwardly and configured to accommodate at least a portion of the electrode assembly. The first cup may have a front side, a rear side opposite to the front side, and a lateral side connecting the front side and the rear side. The sealing part may include a front sealing part extending from the front side of the first cup and disposed at a lower position than an upper end of the rear side of the first cup.

The battery according to an embodiment of the disclosure may include an electrode assembly. The battery may include a pouch including an upper pouch, a lower pouch, and a sealing part formed at edges of the upper pouch and the lower pouch to seal the electrode assembly. The lower pouch may include a first cup recessed downwardly and configured to accommodate at least a portion of the electrode assembly. The first cup may include a front side, a rear side opposite to the front side, and a lateral side connecting the front side and the rear side. The sealing part may include a front sealing part extending from the front side of the first cup and disposed at a lower position than an upper end of the rear side of the first cup.

The pouch according to an embodiment of the disclosure may include an upper pouch accommodating to at least a portion of an electrode assembly. The pouch may include a lower pouch accommodating to at least a portion of the electrode assembly and connected to the upper pouch. The pouch may include a sealing part formed at edges of the upper pouch and the lower pouch to seal the electrode assembly. The lower pouch may include a first cup recessed downwardly and configured to accommodate at least the portion of the electrode assembly. The sealing part may include a front sealing part extending from a front of the first cup and having a height lower than an uppermost height of the first cup.

According to various embodiments of the disclosure, it is possible to reduce the height of the front sealing part of the pouch by forming the pouch, e.g., the cup, in an asymmetrical shape. Accordingly, interference between the supporting bracket of the housing and the FPCB connected to the PCM may be reduced, freeing limitations to, e.g., a structure and/or shape of the FPCB and the supporting bracket. Further, as a side sealing part is folded downward so that an insulating tape and an attaching tape are located on substantially a same side (e.g., a bottom surface of the battery), a reduction in battery capacity, due to a thickness of the insulating tape, may be compensated. Further, as a remaining folding portion near an edge which occurs during folding in a side of the related art sealing part may be deleted, a degree of freedom of design of the PCM may be enhanced.

Effects of the disclosure are not limited to the foregoing, and other unmentioned effects would be apparent to one of ordinary skill in the art from the following description. In other words, unintended effects in practicing embodiments of the disclosure may also be derived by one of ordinary skill in the art from the embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to various embodiments of the disclosure;

FIG. 2 is a front perspective view illustrating an electronic device according to various embodiments of the disclosure;

FIG. 3 is a rear perspective view illustrating an electronic device according to various embodiments of the disclosure;

FIG. 4 is an exploded perspective view illustrating an electronic device according to various embodiments of the disclosure;

FIG. 5 is a perspective view illustrating a state of a battery after a pouch is sealed according to an embodiment of the disclosure;

FIG. 6 is a perspective view illustrating a state of a battery before a pouch is sealed according to an embodiment of the disclosure;

FIG. 7 is a cross-sectional view illustrating a pouch, taken along line A-A′ of FIG. 6, according to an embodiment of the disclosure;

FIG. 8 is a side view illustrating a pouch of FIG. 6 according to an embodiment of the disclosure;

FIG. 9 is a perspective view illustrating a state in which a protection circuit module is connected to a battery according to an embodiment of the disclosure;

FIG. 10 is a front view illustrating a state in which a battery connected with a protection circuit module is seated in an electronic device according to an embodiment of the disclosure;

FIG. 11 is a view illustrating a manufacturing process of a pouch according to an embodiment of the disclosure;

FIGS. 12A and 12B are views illustrating states before/after a sealing part is cut according to an embodiment of the disclosure;

FIG. 13 is a view illustrating a first folding state of a side sealing part according to an embodiment of the disclosure;

FIG. 14A is a view illustrating a second folding state of a side sealing part of a pouch according to an embodiment of the disclosure;

FIG. 14B is an enlarged view of portion A shown in FIG. 14A according to an embodiment of the disclosure;

FIG. 15A is a perspective view of a pouch according to the related art;

FIG. 15B is a front view illustrating a state in which a protection circuit module is seated on the pouch according to the related art;

FIG. 16A is a perspective view of a pouch according to an embodiment of the disclosure; and

FIG. 16B is a front view illustrating a state in which a protection circuit module is seated on a pouch according to an embodiment of the disclosure.

The same or similar reference denotations may be used to refer to the same or similar elements throughout the specification and the drawings.

### DETAILED DESCRIPTION

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is located “on” another component, the first component may be located directly on the second component, or other component(s) may be located between the first and second component.

The term “and/or” may denote a combination(s) of a plurality of related components as listed or any of the components.

Hereinafter, the working principle and embodiments of the disclosure are described with reference to the accompanying drawings.

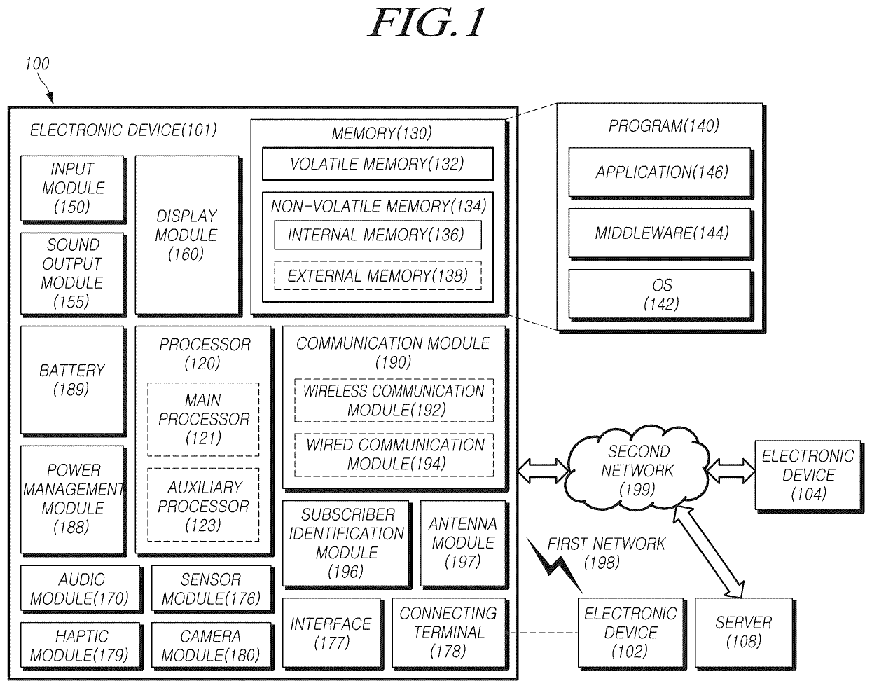

FIG. 1 is a block diagram illustrating an electronic device in a network environment according to an embodiment of the disclosure.

Referring to FIG. 1, an electronic device 101 in a network environment 100 may communicate with at least one of an electronic device 102 via a first network 198 (e.g., a short-range wireless communication network) or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module 196, or an antenna module 197. In an embodiment, at least one of the components (e.g., the connecting terminal 178) of the components may be omitted from the electronic device 101, or one or more other components may be added in the electronic device 101. According to an embodiment, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a CPU or an AP), or an auxiliary processor 123 (e.g., a GPU, a NPU, an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for AI model processing. The AI model may be generated via machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network, a convolutional neural network, a recurrent neural network, a restricted Boltzmann machine, a deep belief network, a bidirectional recurrent deep neural network, deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. For example, the non-volatile memory 134 may include internal memory 136 and external memory 138.

The program 140 may be stored in the memory 130 as software, and may include, for example, an operating system 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a USB interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit.

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system communication module) or a wired communication module 194 (e.g., a local area network (LAN) communication module or a power line communication module). A corresponding one of these communication modules may communicate with the external electronic device 104 via a first network 198 (e.g., a short-range communication network, such as Bluetooth™, Wi-Fi direct, or IR data association) or a second network 199 (e.g., a long-range communication network, such as a legacy cellular network, a 5th generation (5G) network, a next-generation communication network, the Internet, or a computer network (e.g., LAN or wide area network). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductive body or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mmWave antenna module may include a PCB, an RFIC disposed on a first side (e.g., the bottom side) of the PCB, or adjacent to the first side and capable of supporting a designated high-frequency band (e.g., the mmWave band), and a plurality of antennas (e.g., array antennas) disposed on a second side (e.g., the top or a lateral side) of the PCB, or adjacent to the second side and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output, serial peripheral interface, or mobile industry processor interface).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing, or client-server computing technology may be used, for example. The electronic device 101 may provide ultra-low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

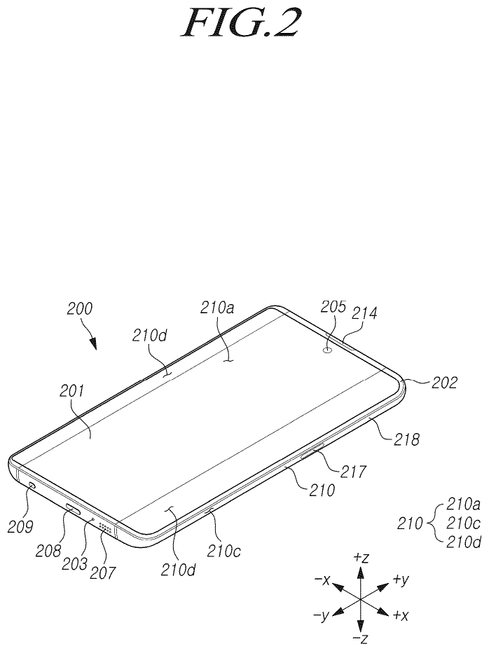

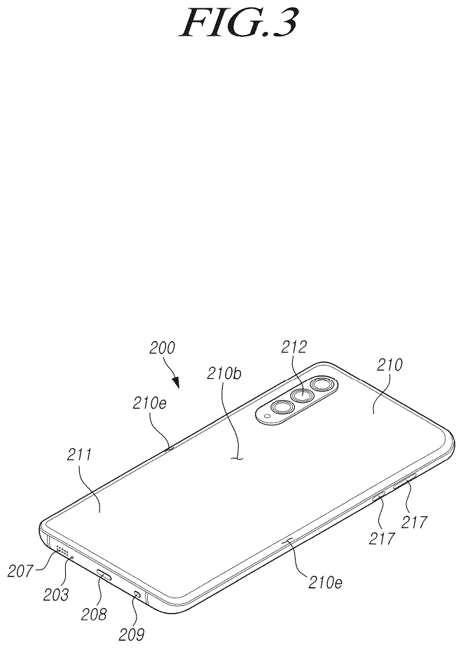

FIG. 2 is a front perspective view illustrating an electronic device according to an embodiment of the disclosure. FIG. 3 is a rear perspective view illustrating an electronic device according to an embodiment of the disclosure.

Referring to FIGS. 2 and 3, an electronic device 200 includes a housing 210 including a front side 210a, a rear side 210b, and a lateral side 210c surrounding a space between the front side 210a and the rear side 210b. The housing 210 may refer to a structure that forms at least any one of the front side 210a, the rear side 210b, and the lateral side 210c. Herein, the term “side” may be interchangeably used as “surface or “surface of a side.”

At least a portion of the front side 210a may be formed by a substantially transparent front plate 202 (e.g., a glass plate, polymer plate, or cover glass including various coating layers). The front plate 202 may be formed of two dimensional (D) glass or 2.5D glass but is not limited thereto.

The rear side 210b may be formed by a rear plate 211. The rear plate 211 may be formed of, e.g., glass, ceramic, polymer, metal (e.g., aluminum, stainless steel, or magnesium), or a combination of at least two of the above-described materials.

The lateral side 210c may be coupled to the front plate 202 and the rear plate 211 to be formed by a bezel 218 of the lateral side 210c (or a “lateral side 210c member”), which includes a metal and/or a polymer. At least one of the bezel 218, the front plate 202, and/or the rear plate 211 may be integrally formed. For example, the bezel 218 and the front plate 202, the bezel 218 and the rear plate 211, or the bezel 218 and the front and rear plates 202 and 211 may be integrally formed with each other. The integrally formed bezel 218 may include glass, a metal material (e.g., aluminum), or ceramic. The other integrally formed components (e.g., the front plate 202 and/or the rear plate 211) integrally formed may include substantially the same material.

The front plate 202 may include two (2) first edge areas 210d, extending seamlessly at two opposite ends of a long edge of the front plate 202, bent from the front side 210a toward the rear plate 211 (e.g., in the −z-axis direction). The rear plate 211 may include two (2) second edge area 210e, extending seamlessly at two opposite ends of the long edge of the rear plate 211, bent from the rear side 210b toward the front plate 202. The front plate 202 (or the rear plate 211) may include only one of the first edge area 210d (or the second edge area 210e). At least some (or portion) of the first edge area 210d or the second edge area 210e may not be included. When at least one of the first edge area 210d or the second edge area 210e is not included, a process for processing the first edge area 210d or the second edge area 210e may be omitted, thereby reducing production costs.

When viewed from one side of the electronic device 200, the bezel 218 may have a first thickness (or width) on a lateral side which does not include the first edge area 210d or the second edge area 210e and may have a second thickness smaller than the first thickness on a lateral side 210c which includes the first edge area 210d or the second edge area 210e.

The electronic device 200 may include at least one of a display 201 (e.g., including the display module 160 of FIG. 1), audio modules 203, 207, and 214 (e.g., including the audio module 170 of FIG. 1), a sensor module (e.g., including the sensor module 176 of FIG. 1), camera modules 205 and 212 (e.g., including the camera module 180 of FIG. 1), an input module 217 (e.g., including the input module 150 of FIG. 1), and/or connector holes 208 and 209 (e.g., including the connecting terminal 178 of FIG. 1). The electronic device 200 may omit at least one of the components or may further include other components.

The display 201 may be visually exposed through at least a portion of the front plate 202. For example, at least a portion of the display 201 may be exposed through the front side 210a and/or the first edge area 210d of the front plate 202. Edge of the display 201 may be formed to be substantially the same as an adjacent outer shape of the front plate 202. In order to increase a visible area of the display 201, a gap between an outer periphery of the display 201 and an outer periphery of the front plate 202 may be formed to be substantially the same.

The side (or the front plate 202) of the housing 210 may include a display area. The display area may be specified (or identified) according to visible or visually exposed area of the display 201. The display area may include a front side 210a and first edge area 210d.

One or more hole areas may be included in a portion (or region) of the display area of the display 201, and the one or more hole areas may include at least one of a sensor area and/or a camera area. One or more sensors may be disposed in the sensor area, and one or more camera modules 205 may be disposed in the camera area. As the camera area is included as at least a portion of the display area, the area allocated to place and install the camera module 205 may be reduced, so that the display area may be designed to be larger. Further, as the sensor area is included as at least a portion of the display area, the area allocated to place and install the sensor may be reduced, so that the display area may be designed to be larger. As such, including a camera area and/or a sensor area as at least a portion of the display area is also referred to as an under panel camera or under panel sensor technology.

The display 201 may include a touch sensing part for detecting and/or sensing a touch input. The touch sensing part may include, but is not limited to, a touch sensing circuit portion, a pressure sensor, and/or a digitizer.

The audio modules 203, 207, and 214 may include, e.g., a microphone hole 203 and speaker holes 207 and 214. One or more microphones for obtaining an external sound may be disposed in the microphone hole 203. A microphone array for detecting a sound and a direction in which the sound is generated or incident may be disposed in the microphone hole 203. The speaker holes 207 and 214 may include an external speaker hole 207 and/or a call receiver hole 214. The speaker hole 207 and the receiver hole 214 may be formed as a single hole or a plurality of individual holes. One or more speakers for emitting sound to the outside may be disposed in the speaker hole 207. The audio modules 203, 207, and 214 are not limited to the above-described structure and/or configuration, and according to the structure of the electronic device 200, only some of the audio modules 203, 207, and 214 may be provided, or a new audio module may be added.

The camera modules 205 and 212 may include at least one of a front camera module 205 and/or a rear camera module 212. The front camera module 205 may be disposed on the front side 210a of the electronic device 200, and the rear camera module 212 may be disposed on the rear side 210b of the electronic device 200. The camera modules 205 and 212 may include one or more lenses, an image sensor, and/or an ISP.

The front camera module 205 may be disposed in a hole area included as at least a portion of the display area but is not limited thereto and may be disposed outside of the display area.

The rear camera module 212 may include various types of cameras. For example, the rear camera module 212 may include different types of camera(s), such as an IR camera, a telephoto camera, and/or a wide-angle camera. The rear camera module 212 may further include a lighting emitting device such as a flash, including a light emitting diode or a xenon lamp.

The rear camera module 212 may include two or more cameras having different specifications. For example, the rear camera module 212 may include a wide-angle camera and/or a telephoto camera. For example, the rear camera module 212 may include a wide-angle camera, an ultra-wide-angle camera, and/or a telephoto camera. For example, the rear camera module 212 may further include an IR camera (e.g., a time of flight (TOF) camera or a structured optical camera). The IR camera may operate as at least a portion of the sensor module. For example, the TOF camera may be operated as at least a portion of a sensor module for detecting a distance to a subject. The two or more cameras included in the rear camera module 212 may be disposed close to each other. Although not limited thereto, the two or more cameras may be arranged in a line or may be arranged to be spaced apart from each other at equal intervals.

The input module 217 may be disposed on at least one lateral side of the housing 210. The input module 217 disposed on at least one lateral side of the housing 210 may be implemented in a form of a hard key (e.g., a physical button). The input module 217 may be implemented in a form of a soft key (e.g., touch or recognition sensor) on the display. The input module 217 may include a sensor module disposed on the rear side 210b of the housing 210.

The connector holes 208 and 209 may include a first connector hole 208 for receiving a connector (e.g., a USB connector) for transmitting/receiving power and/or data with an external electronic device and/or a second connector hole 209 (e.g., an earphone jack) for transmitting/receiving audio signals with an external electronic device.

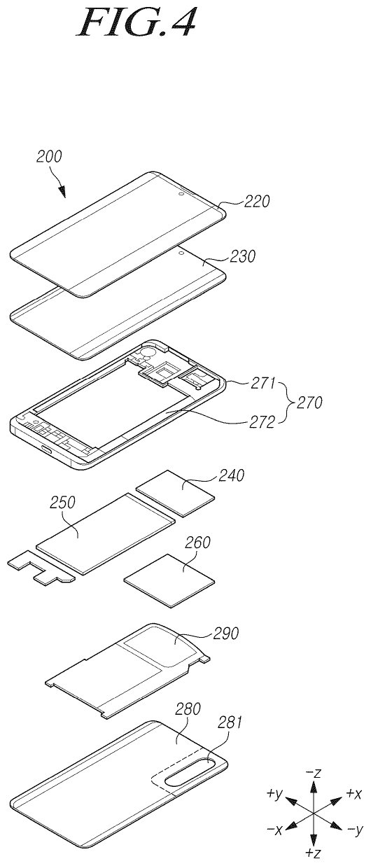

FIG. 4 is an exploded perspective view illustrating an electronic device according to an embodiment of the disclosure.

Referring to FIG. 4, an electronic device 200 may include a supporting bracket 270, a front plate 220 (e.g., the front plate 202 of FIG. 2), a display 230 (e.g., the display 201 of FIG. 2), a PCB 240, a battery 250 (e.g., the battery 189 of FIG. 1), a rear case 260, an antenna 290 (e.g., the antenna module 197 of FIG. 1), and/or a rear plate 280 (e.g., the rear plate 211 of FIG. 3). The supporting bracket 270 of the electronic device 200 may include a bezel 271 (e.g., the bezel 218 of FIG. 2) and a supporting member 272.

The electronic device 200 may omit at least one of the components or may further include other components. For example, the supporting member 272 and/or the rear case 260 among the components of the electronic device 200 may be omitted. For example, the electronic device 200 may further include a deco film. At least one of the components of the electronic device 200 may be the same as or similar to at least one of the components of the electronic device of FIGS. 2 and 3, and no duplicate description is given.

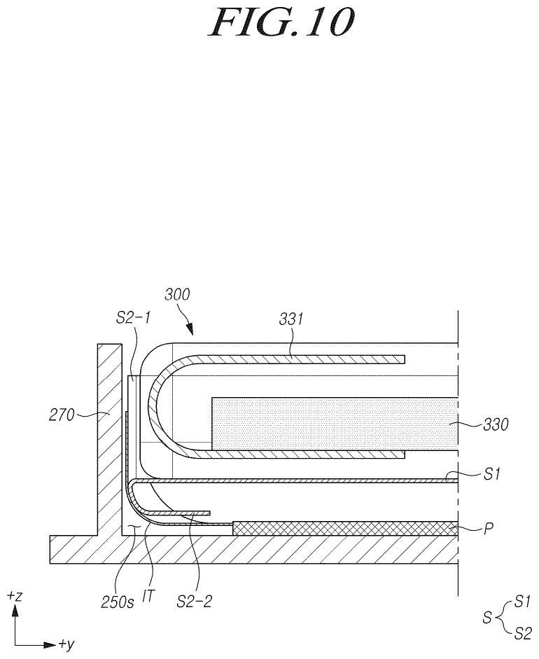

The supporting member 272 may be disposed inside the electronic device 200 to be connected to the bezel 271 or may be integrally formed with the bezel 271. The supporting member 272 may be formed of, e.g., a metal material and/or a non-metal material (e.g., polymer). The display 230 may be disposed on a side (or surface) of the supporting member 272, and the PCB 240 may be disposed on the other side (or surface) of the supporting member 272. A battery slot (e.g., a battery slot 250s of FIG. 10), in which the battery 250 is accommodated, may be formed inside the supporting member 272.

One or more processors, one or more memories, and/or interfaces may be disposed on the PCB 240. The processor, the memory, and/or the interface may be the same as or similar to the processor 120, the memory 130, and/or the interface 177 of the electronic device 101 of FIG. 1, and no duplicate description is given. The processor, the memory, and/or the interface may be mounted on the PCB 240 in a form of independent electronic components or in a form of an electronic component in which at least one electronic component is integrated.

The battery 250 may be a device for supplying power to at least one component of the electronic device 200. The battery 250 may include, e.g., a primary cell which is not rechargeable, a secondary cell which is rechargeable, or a fuel cell.

According to an embodiment, the battery 250 may be electrically connected to the PCB 240 to supply power to components disposed on the PCB 240. At least a portion of the battery 250 may be disposed on substantially the same plane as the PCB 240.

The battery 250 may be integrally disposed inside the electronic device 200. The battery 250 may be detachably disposed with the electronic device 200. In an embodiment, the battery 250 may be accommodated in the battery slot 250s provided in the supporting bracket 270.

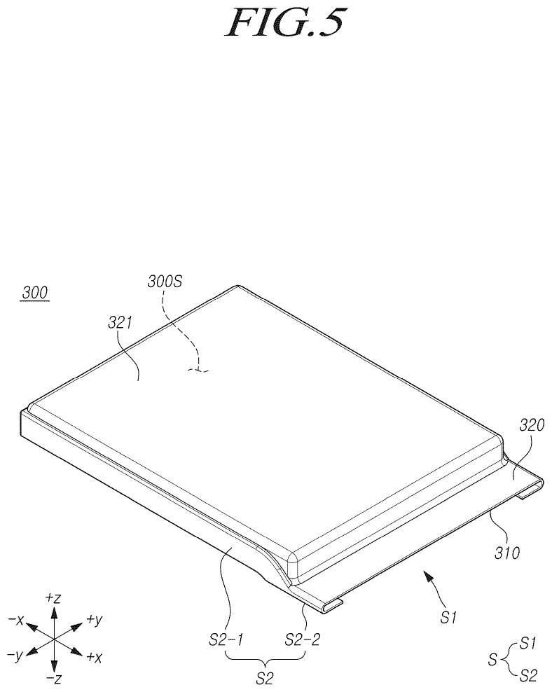

According to an embodiment, the battery 250 may include an electrode assembly (not shown), an electrode lead (not shown), and a pouch (e.g., a pouch 300 of FIG. 5).

According to an embodiment, the electrode assembly (not shown) may be accommodated in the pouch 300. According to an embodiment, the electrode assembly may include a positive electrode plate, a negative electrode plate, a separator, and an electrode tab. In an embodiment, the electrode assembly may be configured in a stacked type in which the separator is interposed between the stacked positive electrode plate and negative electrode plate. In an embodiment, the electrode assembly may be configured in a jelly-roll type in which the positive electrode plate and the negative electrode plate are wound (or wrapped) with the separator interposed therebetween.

According to an embodiment, the positive electrode plate may be formed by applying a positive electrode active material to a current collector plate formed of aluminum. According to an embodiment, the negative electrode plate may be formed by applying a negative electrode active material to a current collector plate formed of copper. According to an embodiment, the electrode tab may include a positive electrode tab corresponding to an area of the positive electrode plate where the positive electrode active material is not applied and a negative electrode tab corresponding to an area of the negative electrode plate where the negative electrode active material is not applied.

According to an embodiment, the electrode lead (not shown) is a thin plate-shaped metal and may be attached to the electrode tab. In an embodiment, the electrode lead may include a positive lead attached to the positive tab and a negative lead attached to the negative tab.

According to an embodiment, the pouch 300 may form an outer appearance of the battery 250. In an embodiment, the pouch 300 may accommodate the electrode assembly and the electrolyte in an inner space. Hereinafter, the structure and/or shape of the pouch 300 is described with reference to FIGS. 5, 6, 7, and 8.

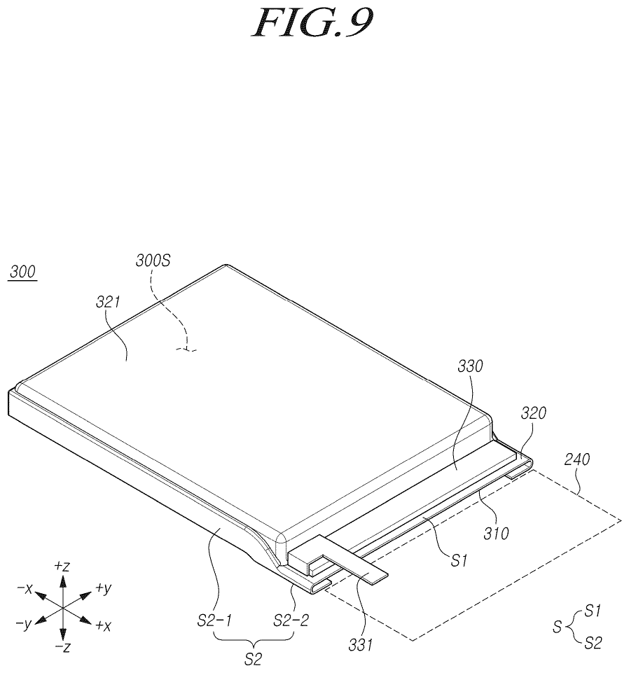

According to an embodiment, the battery 250 may further include a PCM (e.g., a PCM 330 of FIG. 9) for protecting and controlling the battery 250. In an embodiment, the PCM 330 may be electrically connected to the electrode assembly. In an embodiment, the PCM 330 may protect the battery 250 by blocking overcharging, over discharging, or overcurrent of the battery 250. For example, the PCM 330 may maintain a voltage within a predetermined range during charging and discharging of the battery 250. For example, the PCM 330 may control the battery 250 to operate under a stable voltage range.

According to an embodiment, the PCM 330 may include one or more circuit elements capable of electrically protecting the battery 250, and a PCB on which one or more circuit elements are disposed.

The rear case 260 may be disposed between the PCB 240 and the antenna 290. The rear case 260 may include one side to which at least one of the PCB 240 or the battery 250 is coupled and/or the other side to which the antenna 290 is coupled.

The antenna 290 may be disposed between the rear plate 280 and the battery 250. The antenna 290 may include, e.g., a NFC antenna, a wireless charging antenna, and/or a magnetic secure transmission antenna. The antenna 290 may perform short-range communication with, e.g., an external device or may wirelessly transmit or receive power necessary for charging. An antenna structure may be formed by a portion or a combination of the bezel 271 and/or the supporting member 272.

The rear plate 280 may form at least a portion of a rear side of the electronic device 200. The rear plate 280 may include an opening 281 for disposing a camera. The opening may be formed at a position where the camera module is disposed. In the disclosure, the term “rear plate” may be interchangeably used with “back cover.”

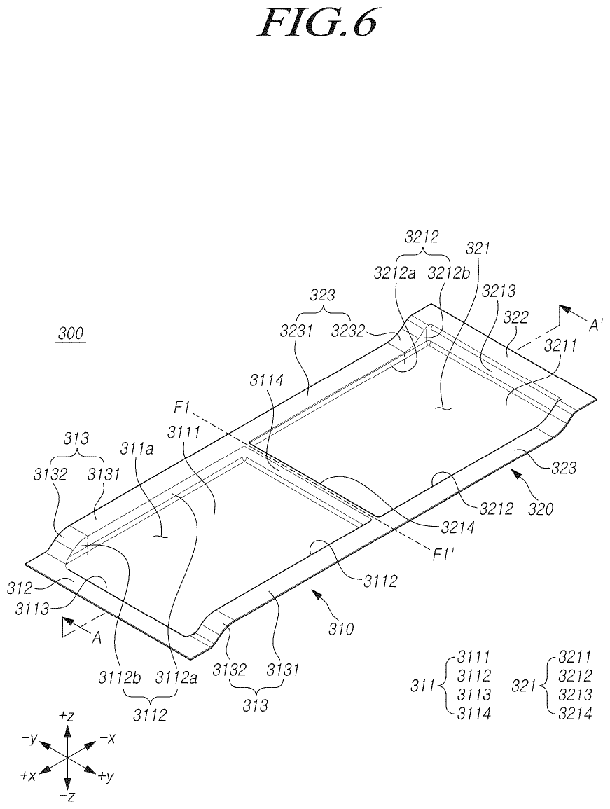

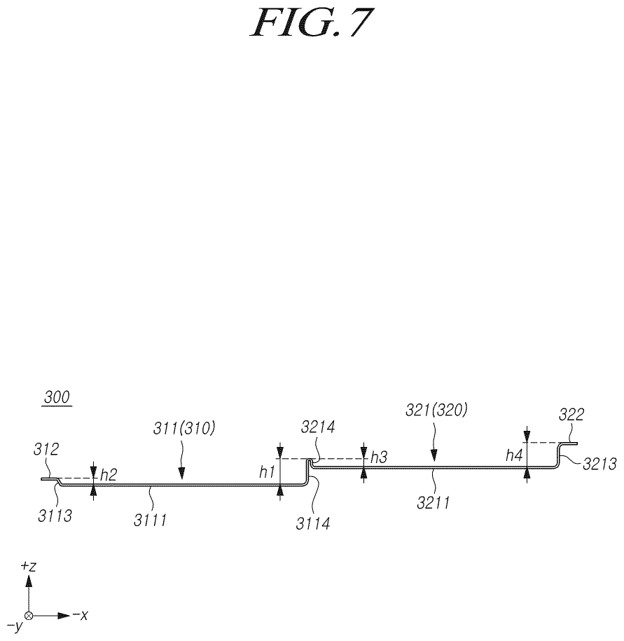

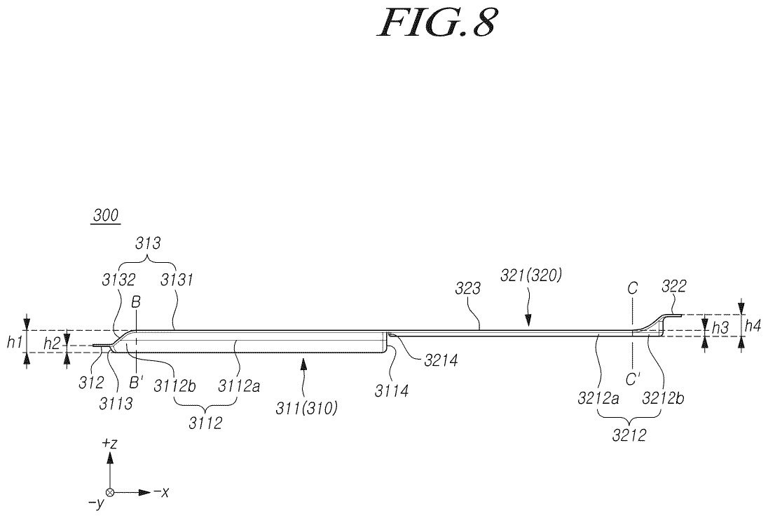

FIG. 5 is a perspective view illustrating a state of a battery after a pouch is sealed according to an embodiment of the disclosure. FIG. 6 is a perspective view illustrating a state of a battery before a pouch is sealed according to an embodiment of the disclosure. FIG. 7 is a cross-sectional view illustrating a pouch, taken along line A-A′ of FIG. 6, according to an embodiment of the disclosure. FIG. 8 is a side view illustrating a pouch of FIG. 6 according to an embodiment of the disclosure.

Referring to FIGS. 5, 6, 7, and 8, a pouch 300 according to an embodiment may include a lower pouch 310 and an upper pouch 320. According to an embodiment, the lower pouch 310 and the upper pouch 320 may overlap each other to form a space 300s in which the electrode assembly is accommodated. In an embodiment, the lower pouch 310 and the upper pouch 320 may be folded (or bent) with respect to a folding line F1-F1′ to contact each other. An area in which the upper/lower pouches 310 and 320 are folded and come into contact with each other may be a sealing part S. The sealing part S may be thermally fused to seal the electrode assembly and the electrolyte contained in the pouch 300.

Hereinafter, the structure and/or shape of the lower pouch 310 and the upper pouch 320 is described with respect to a state prior to being sealed with the lower pouch 310 and the upper pouch 320 (see FIGS. 6, 7, and 8).

According to an embodiment, the lower pouch 310 may include a first cup 311, a front part 312, and a side part 313.

According to an embodiment, the first cup 311 of the lower pouch 310 may form a space 311a in which at least a portion of the electrode assembly is accommodated. According to an embodiment, the first cup 311 may be provided inside the lower pouch 310.

According to an embodiment, the first cup 311 may be recessed downward (e.g., in the −z-axis direction). According to an embodiment, the first cup 311 may be formed in an asymmetric shape. In an embodiment, the first cup 311 may be formed to decrease in height from the rear (e.g., the −x-axis direction) to the front (e.g., the +x-axis direction) in a predetermined section.

According to an embodiment, the first cup 311 may include a bottom side 3111 on which the electrode assembly is seated, lateral side 3112 extending upward (e.g., in the +z-axis direction) from two opposite side ends (e.g., edges of the bottom side 3111 perpendicular to the y-axis) of the bottom side 3111, a front side 3113 extending upward from a front end (e.g., an edge adjacent to the +x-axis direction among edges of the bottom side 3111 perpendicular to the x-axis) of the bottom side 3111, and a rear side 3114 extending upward from a rear end (e.g., an edge adjacent to the −x-axis direction among edges of the bottom side 3111 perpendicular to the x-axis) of the bottom side 3111. In an embodiment, the front side 3113 and the rear side 3114 of the first cup 311 may face each other.

According to an embodiment, the lateral side 3112 of the first cup 311 may include a first part 3112a and a second part 3112b. In an embodiment, the first part 3112a and the second part 3112b may be divided into front and rear (e.g., +x-axis direction) areas with respect to the line B-B′ illustrated in FIG. 8.

In an embodiment, the first part 3112a may extend from the rear side 3114 of the first cup 311 toward the front (e.g., a direction facing in the +x-axis) at the same height h1 in a predetermined section. In an embodiment, the second part 3112b may extend from the first part 3112a toward (e.g., in the direction of) the front side 3113 of the first cup 311 in a predetermined section and may decrease in height as it approaches the front side 3113.

For example, the height of the uppermost end of the second part 3112b may be the same as the height h1 of the first part 3112a. The height of the second part 3112b may gradually decrease as it approaches the front side 3113 (e.g., in the +x-axis direction), and reach the same height as the height h2 of the front side 3113 of the first cup 311 or the front part 312 to be described below. The height h1 of the uppermost end of the second part 3112b may correspond to the height of the uppermost point (e.g., in the +z-axis direction) among the points (e.g., the points constituting line B-B′) contacting the first part 3112a and the second part 3112b.

According to an embodiment, the front part 312 of the lower pouch 310 may be disposed in front (or front area) of the first cup 311 (e.g., in the +x-axis direction). According to an embodiment, the front part 312 may be connected to the front side 3113 of the first cup 311. According to an embodiment, the front part 312 may extend in the left and right directions (e.g., the ±y-axis direction) along the front side 3113 of the first cup 311.

According to an embodiment, the side part 313 of the lower pouch 310 may be disposed to a side (e.g., in the ±y-axis direction) of the first cup 311. According to an embodiment, the side part 313 may be connected to the lateral side 3112 of the first cup 311. According to an embodiment, the side part 313 may extend in the front-rear direction (e.g., the +x-axis direction) along the lateral side 3112 of the first cup 311.

According to an embodiment, the side part 313 may include a flat portion 3131 extending along the first part 3112a of the lateral side 3112 and a curved portion 3132 extending along the second part 3112b of the lateral side 3112.

According to an embodiment, the curved portion 3132 may be connected to the flat portion 3131 and the front part 312. In an embodiment, a height of the curved portion 3132 may decrease from the flat portion 3131 to the front part 312. In an embodiment, the curved portion 3132 may include an inclined (or angled) side having a predetermined inclination or a curved side having a predetermined curvature.

According to an embodiment, the upper pouch 320 may include a second cup 321, a rear part 322, and a side part 323.

According to an embodiment, the upper pouch 320 and the lower pouch 310 may have structures and/or shapes corresponding to each other when folded or in a folding state.

According to an embodiment, as illustrated in FIG. 6, the rear part 322 and the side part 323 of the upper pouch 320 may be provided to be symmetrical to the front part 312 and the side part 313 of the lower pouch 310, respectively, with respect to the folding line F1-F1′. In an embodiment, the flat portion 3131 of the lower pouch 310 and a flat portion 3231 of the upper pouch 320, which is described below, may share the same plane with each other.

According to an embodiment, the second cup 321 of the upper pouch 320 may accommodate at least a portion of the electrode assembly. When the lower pouch 310 and the upper pouch 320 come into contact with each other and the edges (e.g., the front part 312, the rear part 322, and the side parts 313 and 323) of the upper/lower pouches 310 and 320 are sealed, the second cup 321 of the upper pouch 320 may form a space 300s in which the electrode assembly is accommodated together with the first cup 311 of the lower pouch 310. In an embodiment, the second cup 321 of the upper pouch 320 may be omitted. If omitted, only the first cup 311 of the lower pouch 310 may form a space 300s in which the electrode assembly is accommodated.

According to an embodiment, the second cup 321 may be recessed downward (e.g., in the −z-axis direction). According to an embodiment, the second cup 321 may be formed in an asymmetric shape. In an embodiment, the second cup 321 may be formed to increase in height from the front (e.g., +x-axis direction) to the rear (e.g., −x-axis direction) in a predetermined section.

According to an embodiment, the second cup 321 may include a bottom side 3211, lateral side 3212 extending upward (e.g., in the +z-axis direction) from two opposite side ends (e.g., edges of the bottom side 3211 perpendicular to the y-axis) of the bottom side 3211, a rear side 3213 extending upward from a rear end (e.g., an edge adjacent to t※-x-axis direction among edges of the bottom side 3211 perpendicular to the x-axis) of the bottom side 3211, and a front side 3214 extending upward from a front end (e.g., an edge adjacent to the +x-axis direction among edges of the bottom side 3111 perpendicular to the x-axis) of the bottom side 3211. In an embodiment, the front side 3214 and the rear side 3213 of the second cup 321 may face each other.

According to an embodiment, the lateral side 3212 of the second cup 321 may include a third part 3212a and a fourth part 3212b. In an embodiment, the third part 3212a and the fourth part 3212b may be divided into front and rear (e.g., ±x-axis direction) areas with respect to the line C-C′ illustrated in FIG. 8.

In an embodiment, the third part 3212a may extend from the front side 3214 of the second cup 321 to the rear (e.g., a direction facing in the −x-axis) at the same height h3 in a predetermined section. In an embodiment, the fourth part 3212b may extend from the third part 3212a to the rear side 3213 of the second cup 321 in a predetermined section and may increase in height as it approaches the rear side 3213. For example, the height of the lowermost end of the fourth part 3212b may be the same as the height h3 of the third part 3212a. The height of the fourth part 3212b may gradually increase as it approaches the rear side 3213 (e.g., in the −x-axis direction) and reach the same height as the height h4 of the rear side 3213 or the rear part 322 of the second cup 321. The height h3 of the lowermost end of the fourth part 3212b may correspond to the height of the uppermost point (e.g., in the +z-axis direction) among the points (e.g., the points constituting line C-C′) contacting the third part 3212a and the fourth part 3212b.

According to an embodiment, the rear part 322 of the upper pouch 320 may be disposed behind the second cup 321 (e.g., in the −x-axis direction). According to an embodiment, the rear part 322 may be connected to the rear side 3213 of the second cup 321. According to an embodiment, the rear part 322 may extend in the left and right directions (e.g., the ±y-axis direction) along the rear side 3213 of the second cup 321.

According to an embodiment, the side part 323 of the upper pouch 320 may be disposed on a side (e.g., in the ±y-axis direction) of the second cup 321. According to an embodiment, the side part 323 may be connected to the lateral side 3212 of the second cup 321. According to an embodiment, the side part 323 may extend in the left and right directions (e.g., the ±x-axis direction) along the lateral side 3212 of the second cup 321.

According to an embodiment, the side part 323 of the upper pouch 320 may include a flat portion 3231 extending along the third part 3212a of the lateral side 3212 and a curved portion 3232 extending along the fourth part 3212b of the lateral side 3212.

According to an embodiment, the curved portion 3232 of the upper pouch 320 may be connected to the flat portion 3231 and the rear part 322. In an embodiment, the curved portion 3232 may increase in height from the flat portion 3231 toward (e.g., in the direction of) the rear part 322. In an embodiment, the curved portion 3232 may include an inclined (or angled) side having a predetermined inclination or a curved side having a predetermined curvature.

According to an embodiment, the sealing part S may include a front sealing part S1 and a side sealing part S2. In an embodiment, the sealing part S may extend along the circumferences of the cups 311 and 321 to surround (or cover) the cups 311 and 321 of the upper/lower pouches 310 and 320. In an embodiment, the sealing part S may overall have a substantially “U” shape when the pouch 300 is viewed from above (e.g., in the +z-axis direction).

According to an embodiment, the front sealing part S1 is an area in which the lower pouch 310 and the upper pouch 320 to come into contact with each other (or overlap) when folded and may form a front side of the pouch 300. In an embodiment, the front sealing part S1 may be formed as the front part 312 of the lower pouch 310 and the rear part 322 of the upper pouch 320 are brought in contact with each other (e.g., overlap) and thermally fused.

According to an embodiment, as the first cup 311 of the lower pouch 310 is asymmetrically formed, the front sealing part S1 may be located at a height h2 lower than the uppermost height h1 of the first cup 311 of the lower pouch 310.

The installation height (or the mounting height) of the PCM (e.g., the PCM 330 of FIG. 9) seated on the front sealing part S1 may also be lowered.

For example, the height of the front sealing part S1 extending from the first cup 311 may be adjusted through asymmetric shape forming of the pouch 300, e.g., asymmetric forming of the shape of the first cup 311, as described above, based on a size, arrangement, and/or connection relationship of the PCM (e.g., the PCM 330 of FIG. 9).

According to an embodiment, the side sealing part S2 is an area in which the lower pouch 310 and the upper pouch 320 are folded to come into contact with each other and may form a lateral side of the pouch 300. In an embodiment, the side sealing part S2 may be formed as the side part 313 of the lower pouch 310 and the side part 323 of the upper pouch 320 are brought in contact with each other (e.g., overlap) and thermally fused.

According to an embodiment, the side sealing part S2 may be sequentially folded a predetermined number of times (e.g., twice) to face the first cup 311 of the lower pouch 310 and at least a portion of the front sealing part S1.

According to an embodiment, the side sealing part S2 may include a first side sealing part S2-1 facing two opposite lateral sides 3112 of the first cup 311 of the lower pouch 310 and a second side sealing part S2-2 facing a lower side of the front sealing part S1.

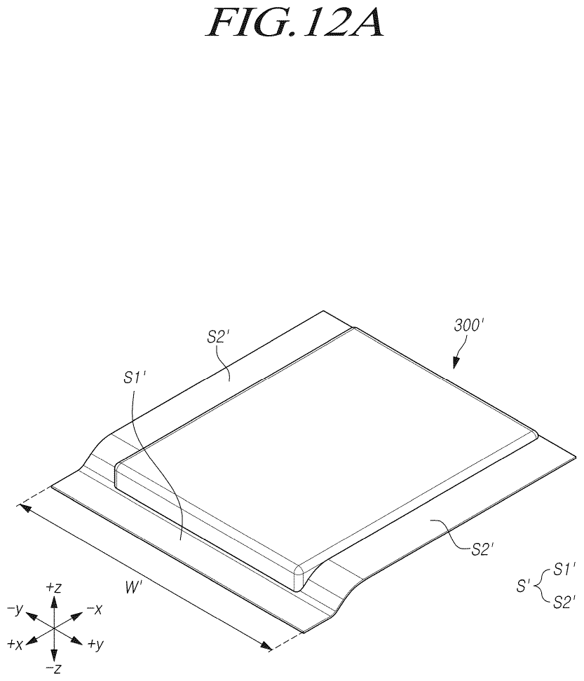

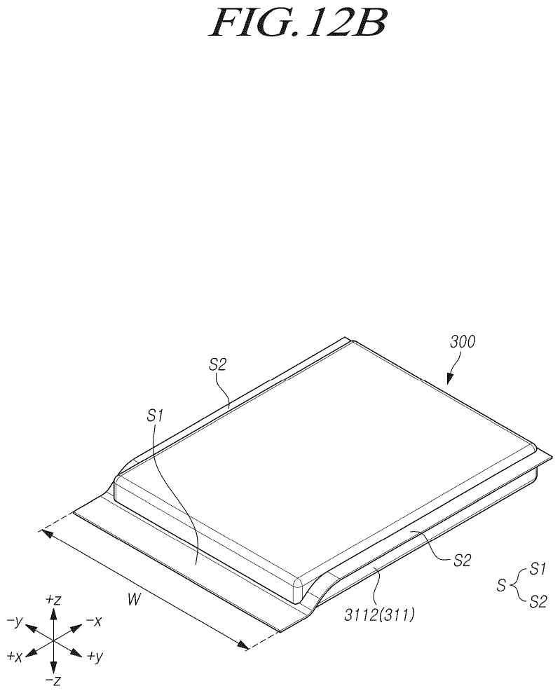

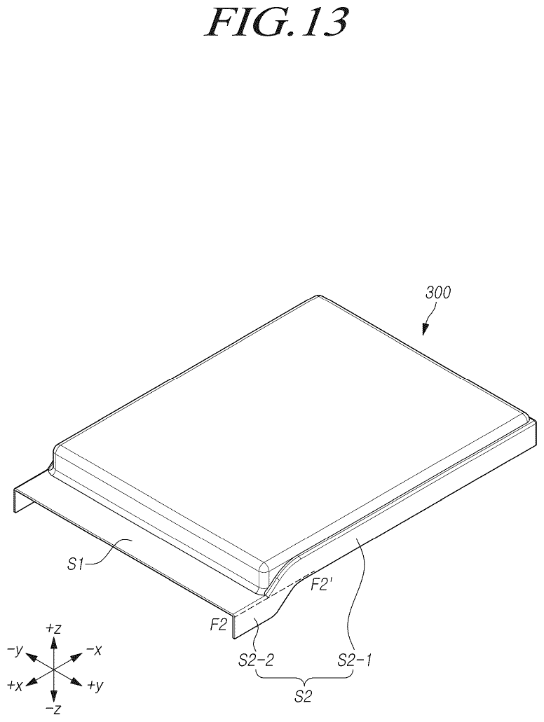

According to an embodiment, the first side sealing part S2-1 may correspond to a portion of the side sealing part S2 that is first folded downward (e.g., in the −z-axis direction) to face two opposite lateral side 3112 of the first cup 311 of the lower pouch 310 (see FIGS. 12 and 13). In an embodiment, the first side sealing part S2-1 may have a shape corresponding to at least a portion of two opposite lateral sides 3112 of the first cup 311 of the lower pouch 310. In this case, the first side sealing part S2-1 may be disposed to overlap the lateral side 3112 of the first cup 311 when folded.

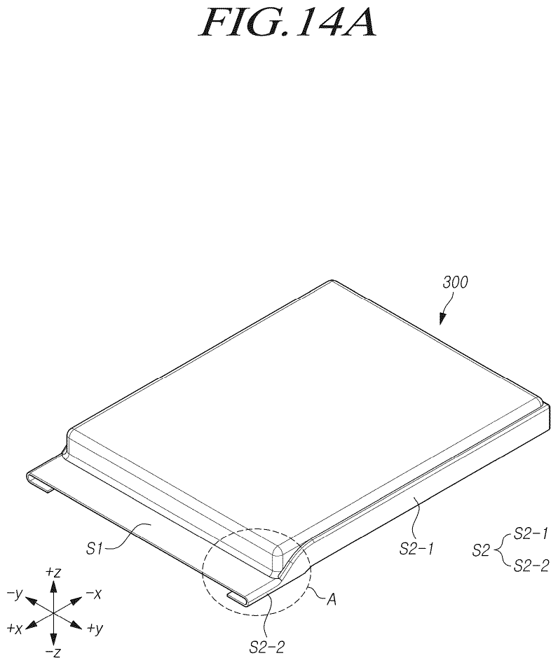

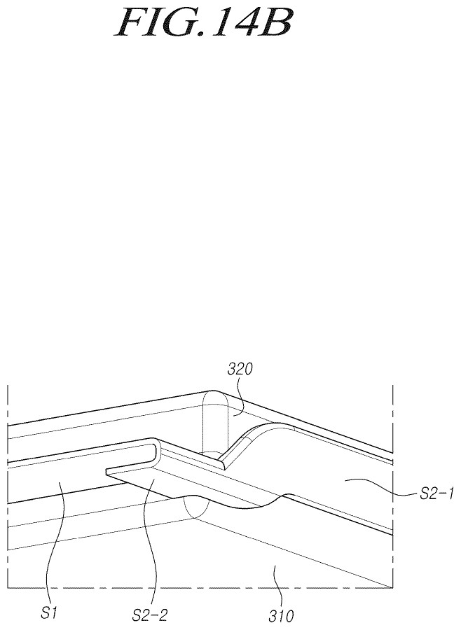

According to an embodiment, after the first folding of the side sealing part S2, the second side sealing part S2-2 may correspond to a portion of the side sealing part S2 formed by the second folding downward (e.g., in the −z-axis direction) to face the lower side of the front sealing part S1 (see FIGS. 13 and 14A).

FIG. 9 is a perspective view illustrating a state in which a PCM is connected to a battery according to an embodiment of the disclosure. FIG. 10 is a front view illustrating a state in which a battery connected with a PCM is seated in an electronic device according to an embodiment of the disclosure.

Referring to FIGS. 9 and 10, a PCM 330 according to an embodiment may further include a FPCB 331 for electrically connecting an electrode assembly (not shown) of a battery (e.g., the battery 250 of FIG. 4) and a PCB 240 of an electronic device (e.g., the electronic device 200 of FIG. 2).

According to an embodiment, the PCM 330 may be disposed on (e.g., in the +z-axis direction) the front sealing part S1 of the pouch 300. According to an embodiment, the FPCB 331 may be bent upward (e.g., in the +z-axis direction) of the front sealing part S1 of the pouch 300 and then extend toward (e.g., in the +x-axis direction) the PCB 240. The FPCB 331 may be disposed to face the second side sealing part S2-2 with respect to the front sealing part S1.

As described above, when the PCM 330 is disposed on the front sealing part S1 of the pouch 300, a bending space and/or a moving space of the FPCB 331 may be secured above the PCM 330. In this case, since an interference between the FPCB 331 and the supporting bracket 270 may disappear, a need for cutting (or removing) a portion of the supporting bracket 270 to secure a bending space of the FPCB 331 may be eliminated, and the FPCB 331 may be freely bent and/or moved within a width (or space corresponding to the width) of the pouch 300 (specifically, within a width of the front sealing part S1). The PCM 330 may also be disposed adjacent to the bracket 270, making it possible to secure a more length of the PCM 330 while reducing the width.

Referring to FIG. 10, the battery 250 according to an embodiment may be fixed or secured, with an adhesive P, to the battery slot 250s provided in the supporting bracket 270. The adhesive P may be attached (or applied) to the bottom side of the battery 250. According to an embodiment, the battery 250 may include an insulating member IT for insulating a section or portion of the side sealing part S2 cut or severed during processing of the pouch 300 (see FIGS. 12A and 12B). The insulating member IT may be attached to a lateral side and/or a lower side of the pouch 300 to surround or cover an edge of the side sealing part S2.

In this case, as the adhesive P is disposed on the lower side of the battery 250 to attach the battery 250 to the supporting bracket 270 and at least a portion of the insulating member IT surrounding the edge of the sealing part S to insulate the battery 250 are located on the same plane (e.g., the lower side of the battery 250), increase in mounting space of the battery 250 in the housing (specifically, the supporting bracket 270) of the electronic device 200 due to a thickness of the members, as compared with when the members are separately attached to each of the upper and lower sides of the battery 250, may be reduced.

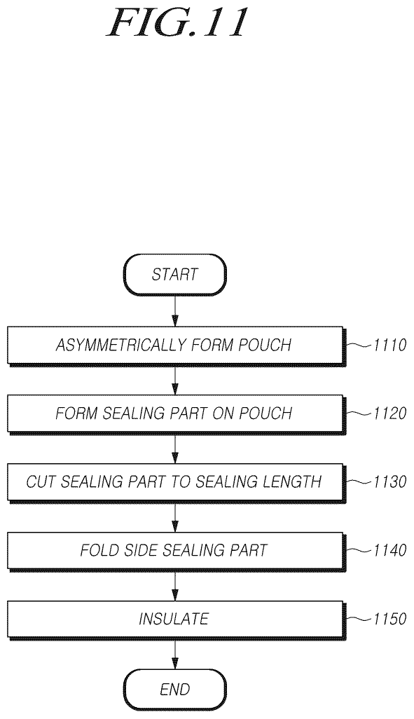

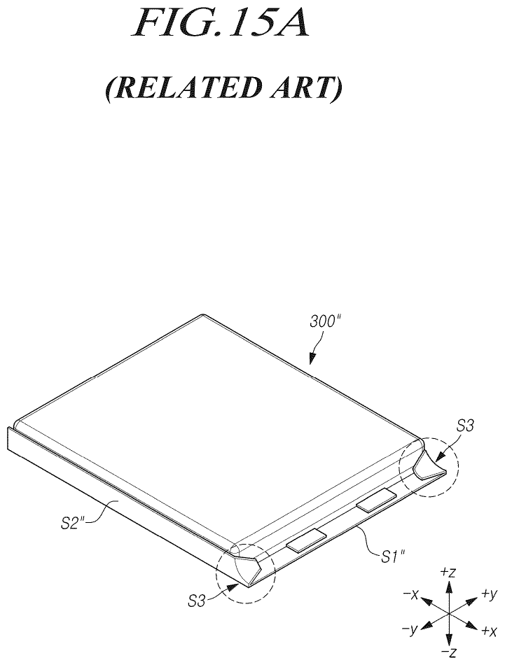

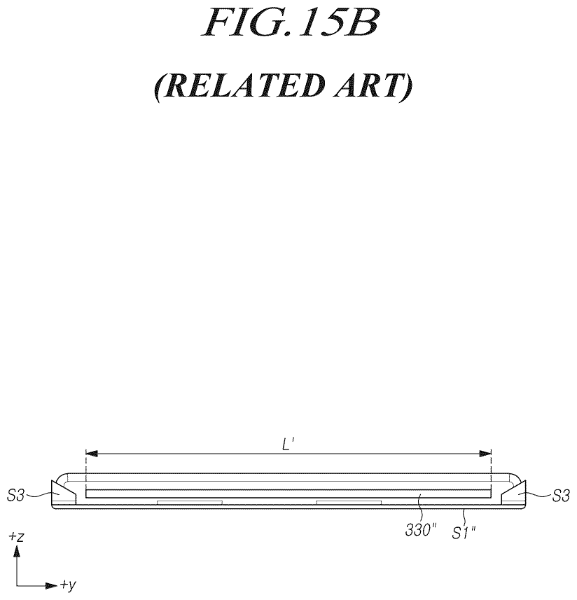

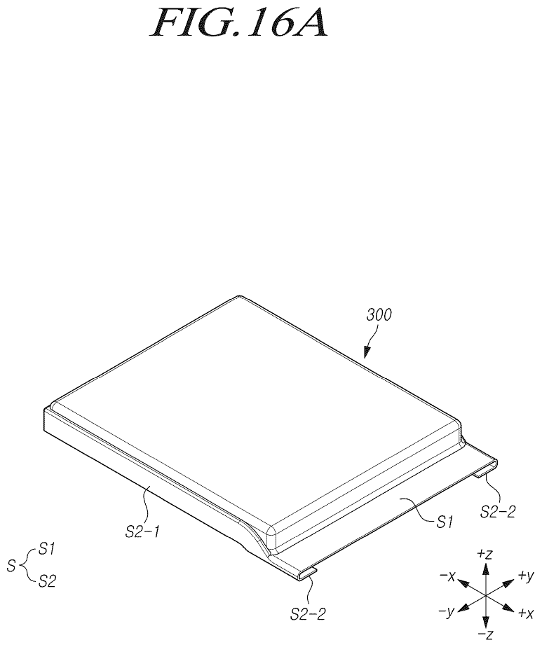

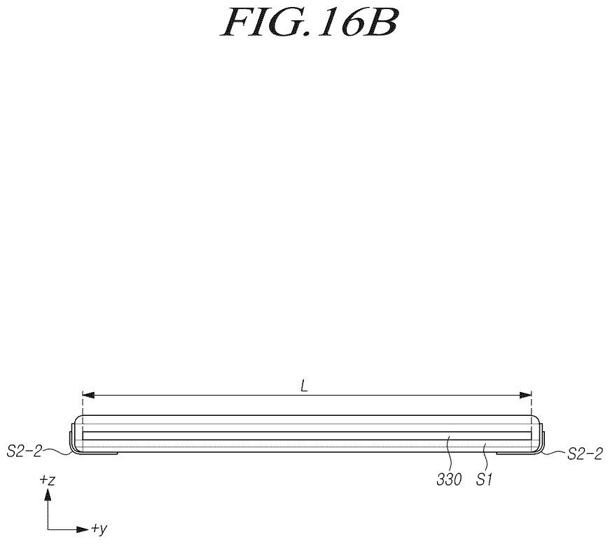

FIG. 11 is a view illustrating a manufacturing process of a pouch according to an embodiment of the disclosure. FIGS. 12A and 12B are views illustrating states before/after a sealing part is cut (or severed) according to an embodiment of the disclosure. FIG. 13 is a view illustrating a first folding state of a side sealing part according to an embodiment of the disclosure. FIG. 14A is a view illustrating a second folding state of a side sealing part of a pouch according to an embodiment of the disclosure. FIG. 14B is an enlarged view of portion A shown in FIG. 14A according to an embodiment of the disclosure. FIG. 15A is a perspective view of a pouch according to the related art. FIG. 15B is a front view illustrating PCM disposed on the pouch according to the related art. FIG. 16A is a perspective view of a pouch according to an embodiment of the disclosure. FIG. 16B is a front view illustrating a state in which a PCM disposed on the pouch according to an embodiment of the disclosure.

Specifically, FIG. 12A is a view illustrating a state before the sealing part S′ (including S1′ and S2′) of the pouch 300′ is cut, and FIG. 12B is a view illustrating a state after the sealing part S of the pouch 300 is cut. FIG. 14B is an enlarged view, from below, of portion A of the pouch 300 in FIG. 14A. FIG. 15A is a perspective view illustrating a pouch 300″ structure of a battery of the related art (e.g., the battery 250 of FIG. 4) according to a comparative example, and FIG. 15B is a front view illustrating a state in which a PCM 330″ is disposed on the pouch 300″ illustrated in FIG. 15A. FIG. 16A is a perspective view illustrating a pouch 300 structure of the battery 250 according to the disclosure, and FIG. 16B is a front view illustrating a state in which the PCM 330 disposed on the pouch 300 illustrated in FIG. 16A.

Hereinafter, a process of manufacturing a pouch 300 of a battery (e.g., the battery 250 of FIG. 4) is described with reference to FIGS. 11, 12A, 12B, 13, 14A, 14B, 15A, 15B, 16A, and 16B.

Referring to FIGS. 11, 12A, 12B, 13, 14A, 14B, 15A, 15B, 16A, and 16B, an upper pouch (e.g., the upper pouch 320 of FIG. 6) and a lower pouch (e.g., the lower pouch 310 of FIG. 6), having an asymmetrical shape, may be formed by using a forming device (not shown) to form a pouch 300 exterior material at operation 1110.

According to an embodiment, a sealing part S of the pouch 300 may be formed by folding the lower pouch 310 and the upper pouch 320 along a folding line (e.g., the folding line F1-F1′ of FIG. 6) to allow the lower pouch 310 and the upper pouch 320 to come into contact with each other and thermally fusing the edges of the upper/lower pouches 310 and 320 at operation 1120.

According to an embodiment, a sealing length (hereinafter, width W′) of the sealing part S′ of the pouch 300′ may be partially cut according to a predetermined width W at operation 1130. Here, a predetermined width W of the pouch 300 may be set based on the size of the battery 250 and/or the size of the battery slot 250s of the supporting member 272. For example, the width W′ of the sealing part S′ of the pouch 300′ may be cut to the predetermined width W such that at least a portion (e.g., the first side sealing part S2-1) of the side sealing part S2 faces at least a portion of the lateral side 3112 of the first cup 311 of the lower pouch 310 when the side sealing part S2, which is described below, is folded (see FIGS. 12A and 12B).

According to an embodiment, in order to reduce the size of the pouch 300, the side sealing part S2 of the pouch 300 may be folded a predetermined number of times to one side at operation 1140. In an embodiment, the side sealing part S2 of the pouch 300 may be folded downward (e.g., in the −z-axis direction) to face the lateral side 3112 of the first cup 311 of the lower pouch 310 (see FIG. 13). Thereafter, the second side sealing part S2-2 of the side sealing part S2 may be once more folded downward (e.g., in the −z-axis direction) along the folding line F2-F2′ to face the lower side of the front sealing part S1 (see FIGS. 14A and 14B).

In the battery pouch 300″ structure of the related art as shown in FIG. 15A, a residue folding portion S3 (e.g., a dog ear portion) is generated on the side of the edge when the side sealing part S2″ is folded and is located inside the front sealing part S1″. However, according to an embodiment, as the pouch 300 is formed in an asymmetrical shape, the residue folding portion S3 of the pouch 300″ as shown in FIG. 15A may be omitted (see FIG. 16A), thereby providing additional degree of freedom in designing the size (e.g., width) of the PCM 330 seated on the front sealing part S1. For example, the width L of the PCM 330 illustrated in FIG. 16B may be designed to be greater than the width L′ of the PCM 330″ illustrated in FIG. 15B.

According to an embodiment, in the edge of the sealing part S, the edge of the side sealing part S2 may be surrounded by an insulating member (e.g., the insulating member IT of FIG. 10) to provide insulation to the battery 250 at operation 1150.

An electronic device 200 according to an embodiment of the disclosure may include a housing 210. The electronic device 200 may include a battery 250 disposed inside the housing 210 to supply power to the electronic device 200. The battery 250 may include an electrode assembly. The battery 250 may include an upper pouch 320 and a lower pouch 310 disposed to accommodate the electrode assembly. The battery 250 may include a sealing part S, formed at an edge of the upper pouch 320 and the lower pouch 310, to seal the electrode assembly. The lower pouch 310 may include a first cup 311 recessed downward to accommodate at least a portion of the electrode assembly. The first cup 311 may include a front side 3113, a rear side 3114 opposite to the front side 3113, and a lateral side 3112 connecting the front side 3113 and the rear side 3114. The sealing part S may include a front sealing part S1 extending from the front side 3113 of the first cup 311 and disposed at a lower height than an upper end of the rear side 3114 of the first cup 311.

According to an embodiment, the battery 250 may include a PCM 330 electrically connected to the electrode assembly. The PCM 330 may be seated on the front sealing part S1.

According to an embodiment, the PCM 330 may include a FPCB 331 that electrically connects the battery 250 and the PCB 240 of the electronic device 200. The FPCB 331 may be bent upward to be located within a width of the front sealing part S1.

According to an embodiment, the sealing part S may include a side sealing part S2 at least partially bent and extended from an upper end of the lateral side 3112 of the first cup 311.

According to an embodiment, the side sealing part S2 may be bent at least twice to at least partially overlap the front sealing part S1 and the lateral side 3112 of the first cup 311.

According to an embodiment, the side sealing part S2 may include a first side sealing part S2-1 bent downward to face the lateral side 3112 of the first cup 311.

According to an embodiment, the first side sealing part S2-1 may have a shape corresponding to at least a portion of the lateral side 3112 of the first cup 311.

According to an embodiment, the side sealing part S2 may include a second side sealing part S2-2 connected to the first side sealing part S2-1 and bent to face a lower side of the front sealing part S1.

According to an embodiment, the battery 250 may include a PCM 330 electrically connected to the electrode assembly. The PCM 330 may be located to face the second side sealing part S2-2 with respect to the front sealing part S1.

According to an embodiment, the first cup 311 may have a bottom side 3111. The front sealing part S1 may be located lower than an upper end position of the rear side 3114 of the first cup 311 with respect to the bottom side 3111.

According to an embodiment, the first cup 311 may have a bottom side 3111. The lateral side 3112 of the first cup 311 may include the first part 3112a having a substantially constant height from the bottom side 3111, and a second part 3112b extending from the first part 3112a toward the front side 3113 and gradually decreasing in height from the bottom side 3111 as it approaches the front side 3113.

The battery 250 according to an embodiment of the disclosure may include an electrode assembly. The battery 250 may include a pouch 300, including an upper pouch 320 and a lower pouch 310, for receiving the electrode assembly and a sealing part S formed at an edge of the upper pouch 320 and the lower pouch 310 to seal the electrode assembly. The lower pouch 310 may include a first cup 311 recessed downward to accommodate at least a portion of the electrode assembly. The first cup 311 may include a front side 3112, a rear side 3114 opposite to the front side 3112, and a lateral side 3113 connecting the front side 3112 and the rear side 3114. The sealing part S may include a front sealing part S1 extending from the front of the first cup 311 and located lower than an upper end of the rear side 3114 of the first cup 311.

According to an embodiment, the battery 250 may further include a PCM 330 electrically connected to the electrode assembly. The PCM 330 may be seated on the front sealing part S1.

According to an embodiment, the PCM 330 may include a FPCB 331 that electrically connects the battery 250 and the PCB 240 of the electronic device 200. The FPCB 331 may be bent upward to be disposed within a width of the front sealing part S1.

According to an embodiment, the sealing part S may include a side sealing part S2 at least partially bent and extended from an upper end of the lateral side 3112 of the first cup 311.

According to an embodiment, the side sealing part S2 may be bent at least twice to at least partially overlap at least a portion of the front sealing part S1 and the lateral side 3112 of the first cup 311.

According to an embodiment, the side sealing part S2 may include a first side sealing part S2-1 bent downward to face the lateral side 3112 of the first cup 311.

According to an embodiment, the side sealing part S2 may include a second side sealing part S2-2 bent downward to face the lower side of the front sealing part S1, as a portion of the side sealing part S2-1 connected to the first side sealing part S2-1.

According to an embodiment, the battery 250 may further include a PCM 330 electrically connected to the electrode assembly. The PCM 330 may be disposed to face the second side sealing part S2-2 with respect to the front sealing part S1.

According to an embodiment, the lateral side 3112 of the first cup 311 may include the flat first part 3112a and a second part 3112b connecting the front sealing part S1 and the first part 3112a. The height of the second part 3112b may gradually decrease toward the front sealing part S1.

The pouch 300 of the battery 250 according to an embodiment of the disclosure may include an upper pouch 320 accommodating at least a portion of an electrode assembly. The pouch 300 may include a lower pouch 310 accommodating at least a portion of the electrode assembly and connected to the upper pouch 320. The pouch 300 may include a sealing part S formed at an edge of the upper pouch 320 and the lower pouch 310 to seal the electrode assembly. The lower pouch 310 may include a first cup 311 recessed downward to accommodate at least a portion of the electrode assembly. The sealing part S may include a front sealing part S1 extending from the front of the first cup 311 and having a height lower than an uppermost height of the first cup 311.

According to an embodiment, the first cup 311 may include a front side 3113, a rear side 3114 opposite to the front side 3113, and a lateral side 3112 connecting the front side 3113 and the rear side 3114.

According to an embodiment, the sealing part S may include a side sealing part S2, at least a portion of which is bent and extended from an upper end of the lateral side 3112 of the first cup 311.

What is claimed is:

1. An electronic device comprising:
a housing; and
a battery disposed inside the housing and configured to supply power to the electronic device,
wherein the battery includes:
an electrode assembly,
an upper pouch and a lower pouch disposed to accommodate the electrode assembly, and
a sealing part formed at edges of the upper pouch and the lower pouch to seal the electrode assembly,
wherein the lower pouch includes a first cup recessed downwardly and configured to accommodate at least a portion of the electrode assembly, the first cup having a front side, a rear side opposite to the front side, and a lateral side connecting the front side and the rear side, and
wherein the sealing part includes a front sealing part extending from the front side of the first cup and disposed at a lower position than an upper end of the rear side of the first cup.

2. The electronic device of claim 1,
wherein the battery includes a protection circuit module electrically connected to the electrode assembly, and
wherein the protection circuit module is disposed at the front sealing part.

3. The electronic device of claim 2,
wherein the protection circuit module includes a flexible printed circuit board electrically connecting the battery and a printed circuit board of the electronic device, and
wherein the flexible printed circuit board is bent upward to be located within a width of the front sealing part.

4. The electronic device of claim 1, wherein the sealing part includes a side sealing part, at least a portion of which is bent and extended from an upper end of the lateral side of the first cup.

5. The electronic device of claim 4, wherein the side sealing part is bent at least twice to at least partially overlap the front sealing part the lateral side of the first cup.

6. The electronic device of claim 4, wherein the side sealing part includes a first side sealing part bent downwardly to face the lateral side of the first cup.

7. The electronic device of claim 6, wherein the first side sealing part has a shape corresponding to at least the lateral side of the first cup.

8. The electronic device of claim 6, wherein the side sealing part includes a second side sealing part connected to the first side sealing part and bent to face a lower side of the front sealing part.

9. The electronic device of claim 8,
wherein the battery includes a protection circuit module electrically connected to the electrode assembly, and
wherein the protection circuit module is located at a position opposite to the second side sealing part based on the front sealing part.

10. The electronic device of claim 1,
wherein the first cup has a bottom side, and
wherein the lateral side of the first cup includes a first part having a substantially uniform height from the bottom side, and a second part extends from the first part toward the front side having a height that gradually decreases from the bottom side toward the front side.

11. A battery comprising:
an electrode assembly; and
a pouch including an upper pouch, a lower pouch, and a sealing part formed at edges of the upper pouch and the lower pouch to seal the electrode assembly,
wherein the lower pouch includes a first cup recessed downwardly and configured to accommodate at least a portion of the electrode assembly,
wherein the first cup includes a front side, a rear side opposite to the front side, and a lateral side connecting the front side and the rear side, and
wherein the sealing part includes a front sealing part extending from the front side of the first cup and disposed at a lower position than an upper end of the rear side of the first cup.

12. The battery of claim 11,
wherein the battery includes a protection circuit module electrically connected to the electrode assembly, and
wherein the protection circuit module is disposed at the front sealing part.

13. The battery of claim 12,
wherein the protection circuit module includes a flexible printed circuit board electrically connecting the battery and a printed circuit board of an electronic device, and
wherein the flexible printed circuit board is bent upward to be located within a width of the front sealing part.

14. The battery of claim 11, wherein the sealing part includes a side sealing part, at least a portion of which is bent and extended from an upper end of the lateral side of the first cup.

15. The battery of claim 14, wherein the side sealing part is bent at least twice to overlap at least partially with at least a portion of the front sealing part and the lateral side of the first cup.

16. The battery of claim 14, wherein the side sealing part includes a first side sealing part bent downwardly to face the lateral side of the first cup.

17. The battery of claim 16, wherein the side sealing part includes a second side sealing part that is a part of the side sealing part connected to the first side sealing part and is bent downward to face a lower side of the front sealing part.

18. The battery of claim 17,
wherein the battery includes a protection circuit module electrically connected to the electrode assembly, and
wherein the protection circuit module is located at a position opposite to the second side sealing part based on the front sealing part.

19. The battery of claim 11,
wherein the lateral side of the first cup includes a flat first part and a second part connecting the front sealing part and the flat first part, and
wherein the second part has a height that gradually decreases toward the front sealing part.

20. A pouch of a battery, the pouch comprising:
an upper pouch accommodating to at least a portion of an electrode assembly;
a lower pouch accommodating to at least portion of the electrode assembly and connected to the upper pouch; and
a sealing part formed at edges of the upper pouch and the lower pouch to seal the electrode assembly,
wherein the lower pouch includes a first cup recessed downwardly and configured to accommodate at least the portion of the electrode assembly, and
wherein the sealing part includes a front sealing part extending from a front of the first cup and having a height lower than an uppermost height of the first cup.
